(19) United States
(12) Patent Application Publication
(10) Pub. No.: US 2021/0352241 A1
(43) Pub. Date: Nov. 11, 2021

(54) RECORDING METHOD AND RECORDING APPARATUS

(71) Applicant: PANASONIC INTELLECTUAL PROPERTY MANAGEMENT CO., LTD., Osaka (JP)

(72) Inventors: Tokuo NAKATANI, Osaka (JP); Kazuhiro MOCHINAGA, Osaka (JP)

(21) Appl. No.: 16/324,802

(22) PCT Filed: Feb. 15, 2018
(86) PCT No.: PCT/JP2018/005164

§ 371 Date: Feb. 11, 2019

Related U.S. Application Data
(60) Provisional application No. 62/552,112, filed on Aug. 30, 2017.

(51) Int. Cl. H04N 5/926; H04N 5/783; H04N 21/845; H04N 21/433

(52) U.S. Cl. CPC H04N 5/926; H04N 21/4334; H04N 21/8455; H04N 5/783

(57) ABSTRACT

A recording method includes: acquiring a video stream containing a picture that is independently decodable; recording the acquired video stream on a recording medium; storing, in memory, a value indicating a data size of a picture defined in a third GOP management table obtained by merging a first GOP management table with a second GOP management table; and converting the stored value into either a first value defined in the first GOP management table or a second value defined in the second GOP management table, and recording the converted value on the recording medium.

### TECHNICAL FIELD

The present invention relates to a recording method for video content and a recording apparatus.

### BACKGROUND ART

Heretofore, techniques relating to Digital Versatile Disc (DVD) have been disclosed (e.g., see PTL 1).

### CITATION LIST

### Patent Literature

PTL 1: Japanese Unexamined Patent Application Publication No. H09-282848

### SUMMARY OF THE INVENTION

### Technical Problem

When performing trick play such as fast forward, a playback device reads I pictures selectively, which are included in a video stream and decodable independently. In a recording medium such as an optical disk, values that indicate data sizes of I pictures are recorded for such trick play. How to record values indicating data sizes of I pictures needs more consideration.

The present disclosure provides a recording method that can adaptively convert and record a value indicating a data size of a picture that is decodable independently.

### Solutions to Problem

A recording method according to an aspect of the present disclosure is a recording method including: acquiring a video stream containing a picture that is independently decodable; recording the acquired video stream on a recording medium; storing, in a memory device, a value that indicates a data size of the picture defined in third table information obtained by merging first table information with second table information; and converting the stored value into one of a first value defined in the first table information and a second value defined in the second table information, and recording the converted value on the recording medium.

Note that these general or specific aspects may be realized by an apparatus, a system, a method, an integrated circuit, a computer program, or a computer-readable recording medium such as a compact disc read only memory (CD-ROM), or by any combination of apparatuses, systems, methods, integrated circuits, computer programs, and recording media.

### Advantageous Effect of Invention

A recording apparatus according to the present disclosure can adaptively convert and record a value indicating a data size of a picture that is decodable independently.

### BRIEF DESCRIPTION OF DRAWINGS

FIG. 1 is a diagram illustrating an example of a first GOP management table.

FIG. 2 is a diagram illustrating an example of a second GOP management table.

FIG. 3 is a diagram illustrating an example of a third GOP management table.

FIG. 4 is a diagram illustrating a schematic configuration of a recording system.

FIG. 5 is a diagram illustrating an example of a program guide of an advanced BS experimental broadcast.

FIG. 6 is a diagram illustrating a directory structure in a BD.

FIG. 7 is a diagram illustrating a schematic configuration of a CLIPINFO file.

FIG. 8 is a diagram illustrating how to generate an address from an EP Map.

FIG. 9 is a diagram illustrating how to generate a timecode from an EP Map.

FIG. 10 is a block diagram illustrating a functional configuration of a recording apparatus according to an embodiment.

FIG. 11 is a flowchart of basic recording operation of the recording apparatus according to the embodiment.

FIG. 12 is a flowchart of recording operation of the recording apparatus according to the embodiment.

FIG. 13 is a block diagram illustrating a detailed functional configuration of a CPU included in the recording apparatus according to the embodiment.

FIG. 14 is another flowchart of the recording operation of the recording apparatus according to the embodiment.

### DESCRIPTION OF EXEMPLARY EMBODIMENTS

### Knowledge Laying the Foundation of the Present Disclosure

A group of pictures (GOP) serves as a unit in encoding a video in conformity to MPEG (Moving Picture Experts Group)-2, MPEG-4 AVC (Advanced Video Coding), or the like. A GOP is a unit that starts with an I picture (Intra-coded picture) and contains a plurality of B pictures (Bidirectionally predictive-coded pictures) and P pictures (Predictive-coded pictures). The pictures are, in other words, frames. An I picture is a picture that is decodable independently of the other kinds of pictures and need not refer to the other kinds of pictures.

The term GOP is not used in High Efficiency Video Coding (HEVC), which is used in 4K broadcast and 8K broadcast, but the term will be used for describing the present specification.

In Blu-Ray (R) Disc Rewritable Format, what is called an entry point (EP) is equivalent to a GOP, and EPs are managed in an entry point map (EP Map). In MPEG-2 and MPEG-4 AVC, it may be considered that one GOP is equivalent to one entry point. In HEVC, it may be considered that a section between I pictures is equivalent to one entry point.

A playback device uses an EP map to search for a playback position to acquire an address and a timecode in a stream file. When acquiring the address and the timecode corresponding to the playback position from the EP map, the playback device reads actual data from a stream data, inputs the data to a decoder, and sets a timecode of the input data.

In a case where a playback device performs trick play, the playback device acquires a size of an I picture from an EP Map, reads only the I picture from a stream file, and displays the I picture. In such a manner, fast-forward playback and fast-reverse playback are implemented.

A resolution of content distributed by the digital broadcasting has been limited to that of full high definition (FHD) (i.e., 2K resolution). As a standard that enables such content to be recorded, Blu-Ray (R) Disc Rewritable Format Part 3 (hereafter, simply referred to as BD standard 3) is established.

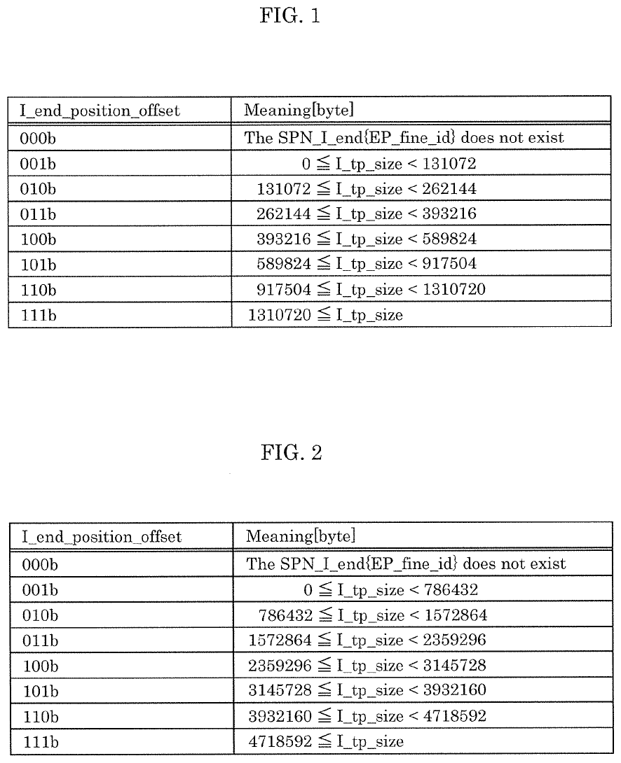

In digital broadcasting, a bit rate of a video stream is as high as about 24 Mbps, and a data size of an I picture included in a GOP in a video stream is about 2 MB. In a GOP management table used in playback, an upper limit of about 2 MB is enough to represent a data size of an I picture, and a playback device uses the GOP management table to implement normal playback and trick play. FIG. 1 is a diagram illustrating an example of such a GOP management table (hereafter, also referred to as a first GOP management table).

In the first GOP management table illustrated in FIG. 1, an I_end_position_offset is 3-bit information that indicates a data size of a section including an I picture in a GOP. For example, when the I_end_position_offset is 001b, the data size of the I picture is 0 or larger and smaller than 131072 bytes.

However, in a case where content of 4K resolution (hereafter, also referred to simply as 4K content) or content of 8K resolution (hereafter, also referred to simply as 8K content) is distributed by the digital broadcasting, a bit rate of its video stream increases twice to four times, and a data size of an I picture also increases proportionately with the bit rate. A conventional GOP management table therefore fails to express a data size of an I picture appropriately, which raises a problem. For example, when a data size of an I picture contained in a video stream of 4K resolution or 8K resolution content is expressed according to the first GOP management table, the I_end_position_offset always stands at a maximum value (i.e., 111b), and acquiring an I picture from a GOP may cause a playback device to read the entire GOP.

Accordingly, when performing trick play using I pictures, the playback device has to read almost the entire video stream. This requires processing such as discarding unnecessary data, which disallows the playback device to perform fast-forward/fast-reverse playback at a speed necessary for the playback.

To solve such a problem, extension of BD standard 3 to adapt to 4K content and 8K content has been under consideration. Specific extension under consideration include to record an I_end_position_offset of a video stream using a GOP management table for high bit rates (hereafter, also referred to as a second GOP management table) in a case where a maximum bit rate of the video stream exceeds 48 Mbps. FIG. 2 is a diagram illustrating an example of the second GOP management table for high bit rates.

According to such extension of BD standard 3, a recording method is conceivable in which recording is carried out by switching the first GOP management table and the second GOP management table with respect to a threshold value of 48 Mbps based on a maximum bit rate of a video stream, for example.

BD standard 3 however specifies that the GOP management tables are switched on the basis of files called CLIPINFO files. Specifically, for one CLIPINFO file, a TS Recording Rate, which represents a maximum bit rate of a video stream, is determined. A playback device refers to the TS Recording Rate to determine which of the first GOP management table and the second GOP management table is used to interpret an I_end_position_offset. As such, it is not possible to use both of the first GOP management table, which is used when a TS Recording Rate is 48 Mbps or lower, and the second GOP management table, which is used when the TS Recording Rate is higher than 48 Mbps, for one CLIPINFO file.

For example, in a possible case, a recording apparatus starts recording 4K content a video stream of which has a maximum bit rate of 48 Mbps or lower, and then the content to be recorded is followed by 8K content. In such a case, the recording apparatus records the I_end_position_offset using a first GOP management table because the maximum bit rate of the video stream is initially 48 Mbps or lower, but when the maximum bit rate of the video stream exceeds 48 Mbps, the recording apparatus has to use a second GOP management table in place of the first GOP management table. To change a GOP management table to be used in such a manner, the recording apparatus has to once close a CLIPINFO file and newly create another CLIPINFO file. In this case, the recording apparatus may fail to record a video stream that is received while the recording apparatus recreates the CLIPINFO file, losing the video stream.

To prevent the video stream from being lost, a conceivable method is to convert the I_end_position_offset from a value defined in the first GOP management table to a value defined in the second GOP management table at a time when the 4K content is switched to the 8K content. This case involves a problem in that the conversion cannot be performed accurately due to incompatibilities between the first GOP management table and the second GOP management table.

Specifically, 101b defined in the first GOP management table can be interpreted as either 001b or 010b n the second GOP management table, and it is therefore not possible to determine which of them 101b should be converted into. Such a problem arises due to a data size of an I picture that is truncated to three bits, which makes an accurate data size of the I picture unknown.

If the two GOP management tables do not overlap each other, the conversion from a value defined in the first GOP management table to a value defined in the second GOP management table can be implemented. In the present case, a range of a size of an I picture that can be expressed as 101b in the first GOP management table extends in two ranges expressed by two values in the second GOP management table, and it is therefore not possible to convert between them simply.

Alternatively, in conceivable measures, the second GOP management table is used to perform the recording from the beginning. Such measurements dispense with a need of creating a new CLIPINFO file at a time of a shift from 4K content to 8K content, which can prevent the loss of a video stream. In this case, however, the second GOP management table is applied to 4K content, which has a relatively low maximum bit rate, which arises a problem of an increase in a ratio of unnecessary data (garbage data) contained in data that is read in trick play.

Although such unnecessary data is not so problematic when a speed of fast-forward is low, when the speed of fast-forward is increased, reading unnecessary data and discharge processing of the unnecessary data by a decoder can adversely affect a playback speed. For example, an extra process for unnecessary data may cause the playback speed to level off.

Furthermore, a Blu-Ray Disc (R) (hereafter, referred to simply as a BD) is played back by an apparatus that records data on the BD as well as other types of apparatuses such as a playback-only apparatus. In a case where a BD is played back by an apparatus having an insufficient performance, there is a risk of a performance problem (insufficient playback speed).

In view of such problems, inventors found a method for recording a data size of an I picture and a recording apparatus that performs such a recording method.

Hereinafter, an embodiment is specifically described with reference to the drawings. Note that the embodiment described below shows a general or specific example. The numerical values, shapes, materials, structural elements, the arrangement and connection of the structural elements, steps, the processing order of the steps etc. illustrated in the embodiment below are mere examples, and are not intended to limit the present disclosure. Moreover, among the structural elements in the embodiment described below, structural elements not recited in any of the independent claims representing the most generic concepts will be described as optional structural elements.

Note that the figures are schematic diagrams and are not necessarily precise illustrations. Additionally, structural elements that are essentially the same share like reference numerals in the figures, and overlapping explanations thereof may be omitted or simplified.

### Embodiment

### [Outline]

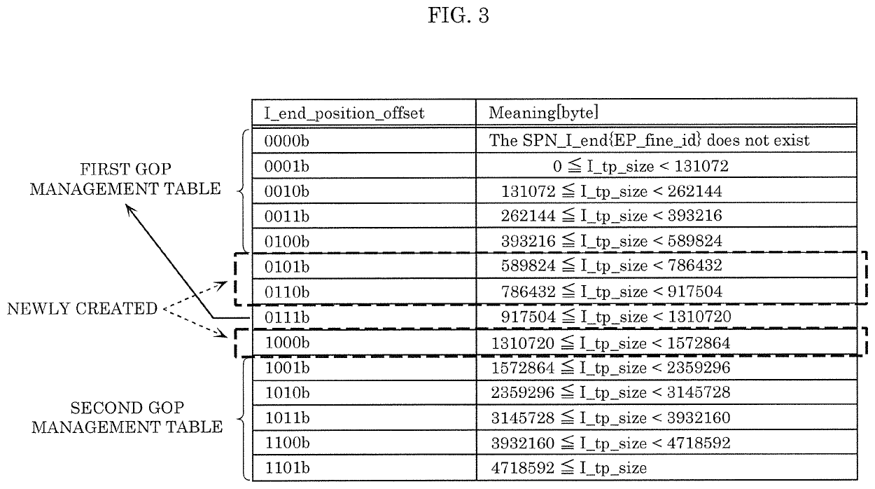

First, a GOP management table that is used by a recording apparatus according to an embodiment (hereafter, also referred to as a third GOP management table) will be described. FIG. 3 is a diagram illustrating an example of the third GOP management table.

In the third GOP management table illustrated in FIG. 3, an I_end_position_offset is 4-bit information. A data size range that is represented as 0000b to 0100b in the third GOP management table corresponds to a data size range that is represented as 000b to 100b in the first GOP management table. A data size range that is represented as 1001b to 1101b in the third GOP management table corresponds to a data size range that is represented as 011b to 111b in the second GOP management table.

In addition, data size ranges that are represented as 0101b, 0110b, and 1000b in the third GOP management table are newly defined. Specifically, the third GOP management table is determined such that values (0101b, 0110b, and 1000b) can be each converted into a value based on the first GOP management table and a value based on the second GOP management table.

For example, the value 0101b in the third GOP management table can be converted to 101b in the first GOP management table and can be converted to 001b in the second GOP management table. The value 0110b in the third GOP management table can be converted to 101b in the first GOP management table and can be converted to 010b in the second GOP management table. The value 1000b in the third GOP management table can be converted to 111b in the first GOP management table and can be converted to 010b in the second GOP management table.

From the above, the third GOP management table is a merged table of the first GOP management table and the second GOP management table. The data size ranges included in the third GOP management table are a sum set (OR set) of data size ranges included in the first GOP management table and data size ranges included in the second GOP management table. The values of the I_end_position_offset defined in the third GOP management table can be uniquely converted into values defined in the first GOP management table and can be uniquely converted into values defined in the second GOP management table.

During recording a video stream, the recording apparatus according to an embodiment uses the third GOP management table to record a value of an I_end_position_offset that is determined based on the third GOP management table, in a memory temporarily. At a time of finishing the recording of the video stream, the recording apparatus according to an embodiment converts the value defined in the third GOP management table into either a value defined in the first GOP management table or a value defined in the second GOP management table according to a maximum bit rate of the video stream, and record the converted value on a BD. In such a manner, a recording method that supports the above extension of BD standard 3 can be implemented.

In addition, managing data sizes of I pictures using information of about several bits as described above suppresses an increase in an amount of memory in the memory. That is, it is possible to suppress an increase in a cost of the memory.

### [Configuration of Recording System]

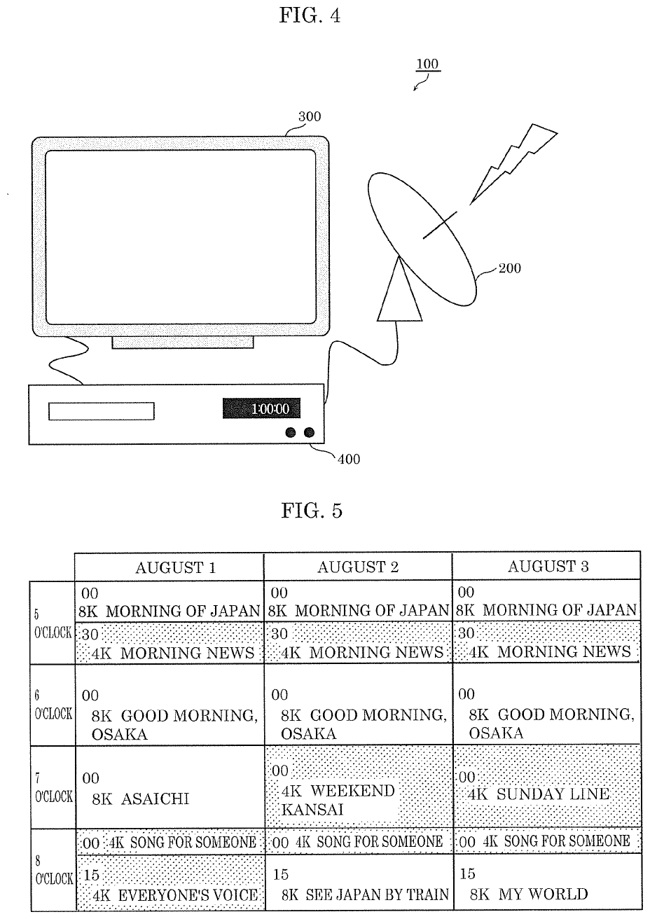

Next, a configuration of a recording system according to an embodiment will be described. FIG. 4 is a diagram illustrating a schematic configuration of the recording system.

As illustrated in FIG. 4, recording system 100 according to an embodiment includes antenna device 200, display device 300 such as a television, and recording apparatus 400.

In recording system 100, when antenna device 200 receives a broadcast wave of 4K content or 8K content, a user can view the content with display device 300. Recording apparatus 400 is, for example, a BD recorder, and the user can record the content on a recording medium such as an HDD or a BD in recording apparatus 400 and playback the recorded content.

In advanced BS broadcasting, 4K content and 8K content may be broadcast intermixedly. FIG. 5 is a diagram illustrating an example of a program guide of an advanced BS experimental broadcast.

As illustrated in FIG. 5, the experimental broadcast includes 4K programs and 8K programs in a mixed manner; when programs on a channel are viewed or recorded, a 4K program can be followed by an 8K program, or conversely an 8K program can be followed by a 4K program. Such broadcasting operation is not only for the experimental broadcasting but also can be carried on after moving to a regular broadcasting.

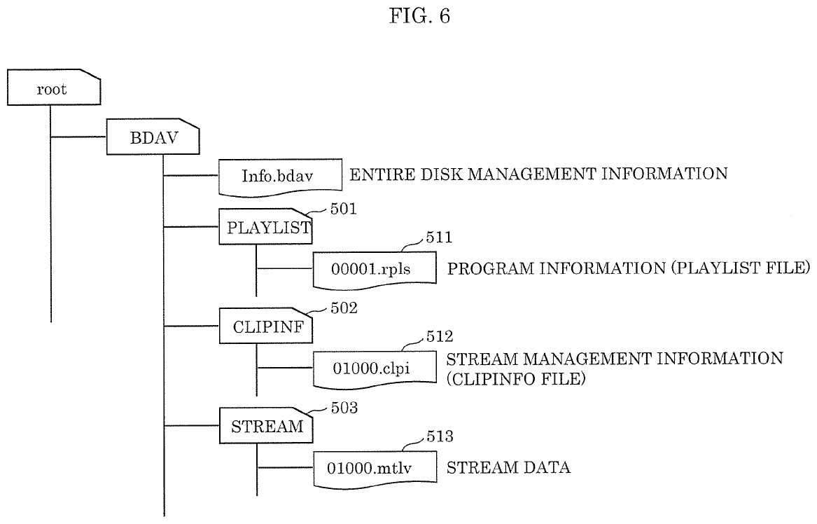

A BD standard for recording a digital broadcast program on a BD is currently being developed. FIG. 6 is a diagram illustrating a directory structure (in other words, a folder structure or a file structure) in a BD defined in the BD standard.

When recording apparatus 400 records a program on a BD, PLAYLIST file 511 is created in PLAYLIST folder 501. PLAYLIST file 511 includes a program name and the like and created on a program-by-program basis.

Meanwhile, actual stream data is recorded in STREAM folder 503 in a form of stream file 513. As information to manage stream file 513, CLIPINFO file 512 is created in CLIPINFO folder 502. CLIPINFO file 512 contains an attribute of the stream, timecodes, an EP Map (hereafter, also referred to as GOP management information), and the like.

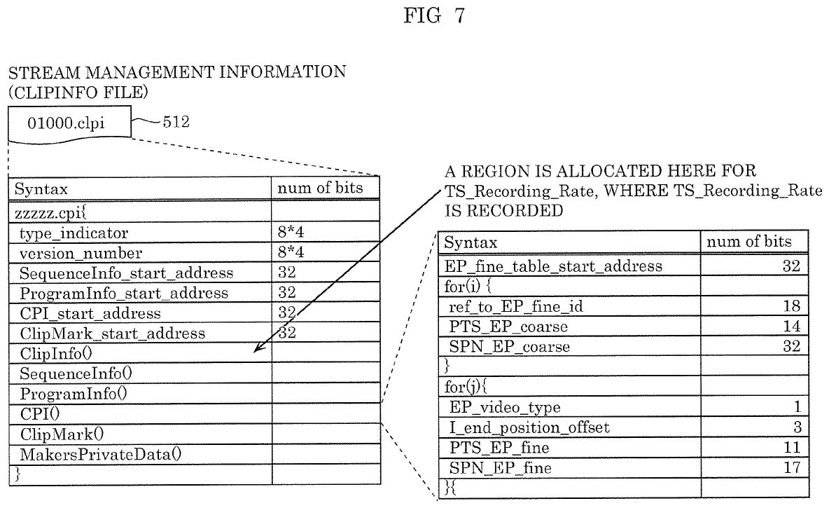

FIG. 7 is a diagram illustrating a schematic configuration of CLIPINFO file 512. As illustrated in FIG. 7, the EP Map is included in a table called CPI. An EP Map has a two-layered structure: COARSE and FINE, such a two-layered structure reduces a size of data necessary to retain information. A TS Recording Rate is recorded on a predetermined area in Clipinfo( ).

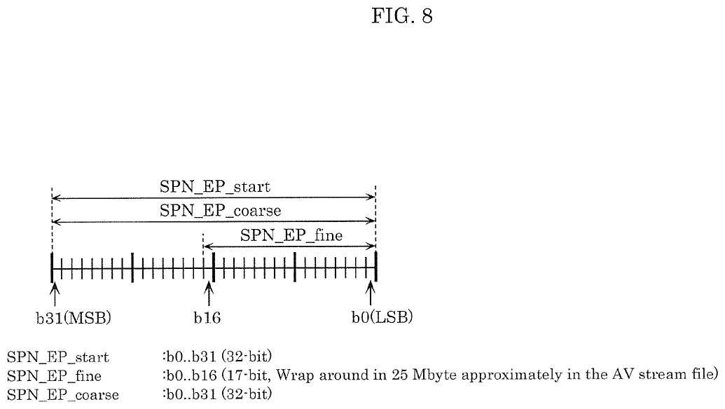

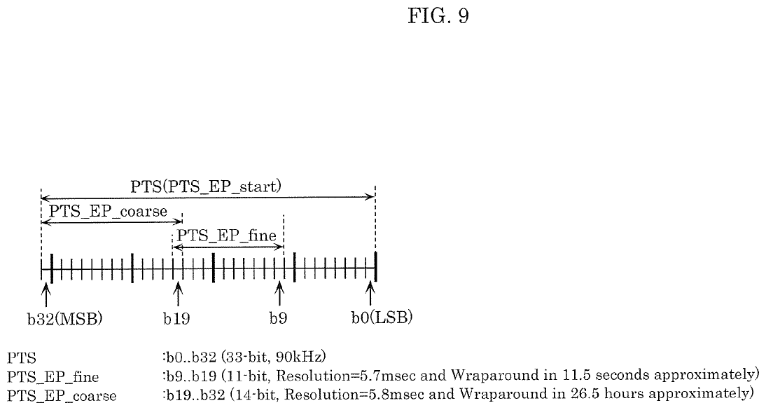

FIG. 8 is a diagram illustrating how to generate an address (Source Packet Number: SPN) from an EP Map, and FIG. 9 is a diagram illustrating how to generate a timecode (Presentation Time Stamp: PTS) from an EP Map. An I_end_position_offset representing a data size of an I picture is present in a Table in the FINE side. Recording apparatus 400 updates the EP Map while continuing recording operation.

### [Detailed Configuration of Recording Apparatus]

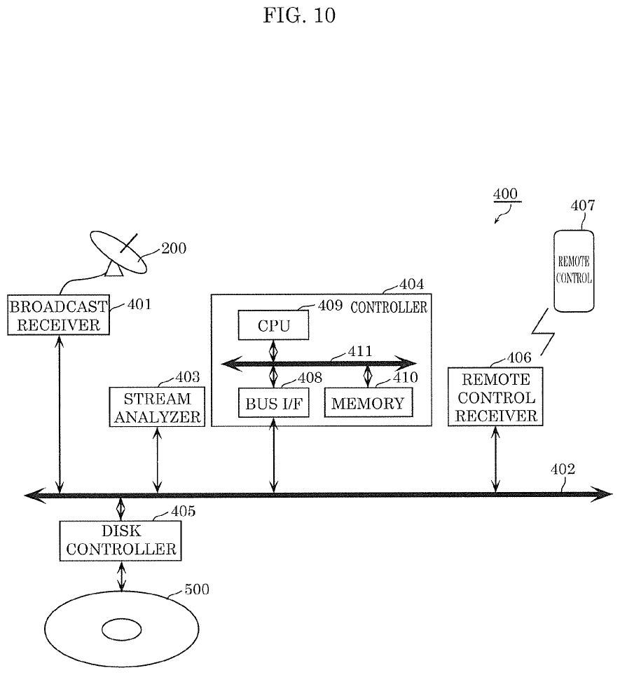

Next, a detailed configuration of recording apparatus 400 will be described. FIG. 10 is a block diagram illustrating a functional configuration of recording apparatus 400. FIG. 10 also illustrates BD 500 as an example of a recording medium.

As illustrated in FIG. 10, recording apparatus 400 includes broadcast receiver 401, bus 402, stream analyzer 403, controller 404, disk controller 405, remote control receiver 406, and remote control 407.

Broadcast receiver 401 is connected to antenna device 200 and acquires broadcast wave received by antenna device 200 in a form of a stream.

Bus 402 is a signal line for transmission of information on a video stream and the like among broadcast receiver 401, stream analyzer 403, controller 404, and remote control receiver 406. The stream acquired by broadcast receiver 401 is transmitted to stream analyzer 403.

Stream analyzer 403 acquires the stream from broadcast receiver 401 and bus 402 and analyzes the stream. Specifically, stream analyzer 403 analyzes SI information contained in the stream and analyzes data on the video stream. By the analyses, stream analyzer 403 identifies information on positions of I pictures, timecodes, data sizes of I pictures, and the like, and transmits the identified information to controller 404 through bus 402.

Controller 404 includes bus I/F 408, central processing unit (CPU) 409, memory 410, and processor bus 411. Specific examples of controller 404 include a microcomputer.

Bus I/F 408 acquires at least a video stream out of streams that is obtained through broadcast receiver 401 and bus 402. Bus I/F 408 is an example of an acquiring unit. The video stream is, in other words, encoded video information. Specifically, bus I/F 408 is a communication module that supports communication through bus 402. The communication module is, in other words, a communication circuit.

CPU 409 performs various kinds of processing relating to recording operation of a video stream. CPU 409 is an example of a record controller. Specific processing performed by CPU 409 will be described later.

Memory 410 is a memory device that stores a program to be performed by CPU 409. Memory 410 also stores the first GOP management table, the second GOP management table, the third GOP management table, and the like. Memory 410 includes a buffer area, in which a video stream, a PLAYLIST file, a CLIPINFO file, and the like are stored temporarily. Memory 410 is provided in a form of a semiconductor memory or the like.

Processor bus 411 is a signal line used by bus I/F 408, CPU 409, and memory 410 for transmission of information.

Disk controller 405 records information on BD 500 under control of CPU 409. Specific examples of disk controller 405 include an optical disk drive apparatus.

Remote control receiver 406 is a device that receives infrared communication signals transmitted from remote control 407. Remote control receiver 406 is, in other words, an infrared receiving device.

Remote control 407 is a user interface with which a user instructs recording apparatus 400 to record a program or the like.

### [Basic Recording Operation of Recording Apparatus]

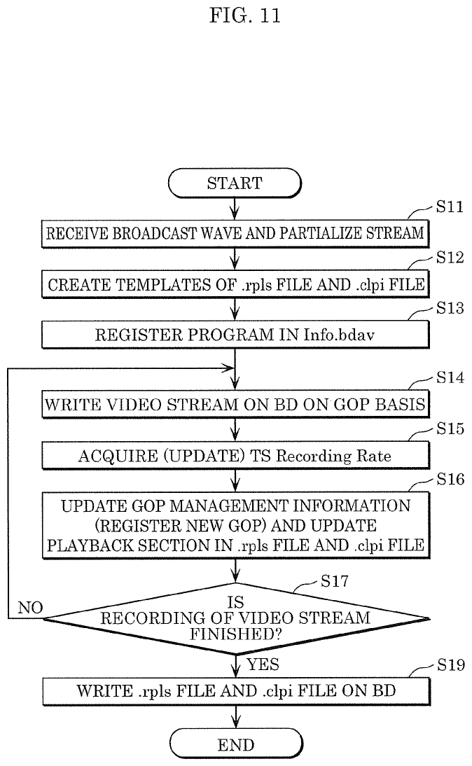

Next, basic recording operation of recording apparatus 400 will be described. FIG. 11 is a flowchart of the basic recording operation of the recording apparatus.

First, broadcast receiver 401 receives a broadcast wave and acquires the received broadcast wave in a form of a stream. Stream analyzer 403 partializes the stream (S11).

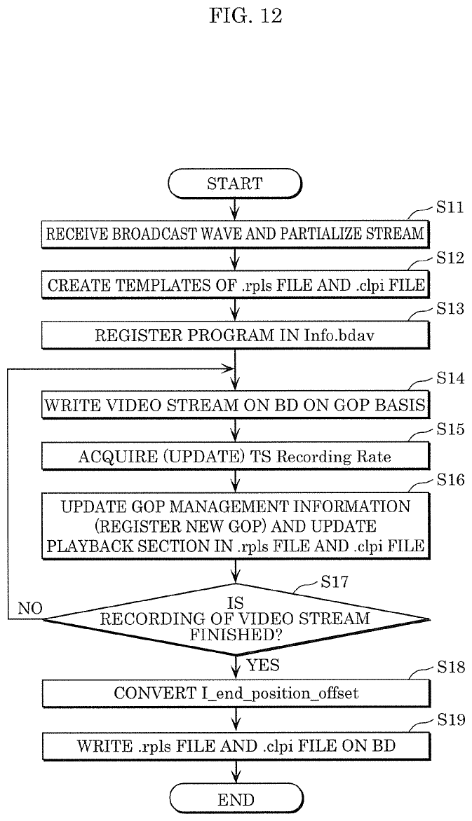

Next, at a time of starting recording a video stream, CPU 409 creates templates of a PLAYLIST file and a CLIPINFO file in memory 410 (S12). CPU 409 registers a recorded program on info.bdav (entire disk management information illustrated in FIG. 6) and controls disk controller 405 to write info.bdav onto BD 500 (S13). This timing to register the program in info.bdav is an example and the registration may be performed with other timings such as after step S17 in FIG. 11 and after step S18 in FIG. 12 described later.

Next, CPU 409 writes the video stream into BD 500 on a GOP basis (S14). CPU 409 specifically stores temporarily the video stream acquired through bus I/F 408 in the buffer area of memory 410. That is, CPU 409 buffers the video stream. CPU 409 then controls disk controller 405 to read the video stream from the buffer area and writes the video stream onto BD 500, on a GOP basis.

CPU 409 acquires a maximum bit rate of the video stream in a form of TS Recording Rate, and when the acquired TS Recording Rate exceeds a TS Recording Rate that is already stored, CPU 409 updates a TS Recording Rate in a CLIPINFO file (S15).

CPU 409 updates the PLAYLIST file and the CLIPINFO file on a GOP basis. CPU 409 specifically updates a playback section in the PLAYLIST file and records a program name and a broadcast duration on the PLAYLIST file. CPU 409 also updates a playback section in the CLIPINFO file and registers information relating to a newly recorded GOP on an EP Map of the CLIPINFO file (hereafter, also referred to as GOP management information) (S16). A process of step S16 includes registration of an I_end_position_offset of the newly recorded GOP.

Processes of step S14 to step S16 are continued until the recording of the video stream is finished (No in S17). When the recording of the video stream on BD 500 is finished (Yes in S17), CPU 409 controls disk controller 405 to write the PLAYLIST file and the CLIPINFO file that are created in memory 410 and updated along with the recording of the video stream, onto BD 500 (S19).

### [Recording Operation of Recording Apparatus]

GOP management information created in memory 410 is normally formed in a format that allows the GOP management information to be written onto BD 500 as it is. This can simplify writing processing.

Such a method however requires creation of a new CLIPINFO file at a time of transition from a state of recording a program having a maximum bit rate of 48 Mbps or lower to a state of recording a program having a maximum bit rate of higher than 48 Mbps. That is, recording of a program may be interrupted.

Hence, recording apparatus 400 performs recording operation as illustrated in a flowchart of FIG. 12. FIG. 12 is a flowchart of recording operation of recording apparatus 400. The flowchart illustrated in FIG. 12 has a configuration in which step S18 is added to the flowchart of FIG. 11.

In step S16 in the flowchart illustrated in FIG. 12, CPU 409 stores temporarily a value of an I_end_position_offset in memory 410 based on the third GOP management table. As described above, a value of an I_end_position_offset defined in the third GOP management table can be uniquely converted into either a value of an I_end_position_offset in the first GOP management table or a value of an I_end_position_offset defined in the second GOP management table. That is, step 16 brings about a condition in which a value of an I_end_position_offset defined in the third GOP management table can be converted into either a value defined in the first GOP management table or a value defined in the second GOP management table.

When the recording of the video stream is finished (Yes in S17), CPU 409 performs the above conversion of a value of the I_end_position_offset (S18). The CLIPINFO file containing the converted I_end_position_offset is then written onto BD 500 (S19).

By such recording operation, it is possible to adaptively record a value of an I_end_position_offset according to the extension of the above BD standard 3 while preventing recording of a program from being interrupted.

In the flowchart of FIG. 12, a timing for the conversion of the I_end_position_offset is when the recording of the video stream is finished. Recording apparatus 400 may however perform the conversion, for example, at a time when a TS Recording Rate rises above 48 Mbps and may thereafter use the second GOP management table rather than the third GOP management table to store the I_end_position_offset.

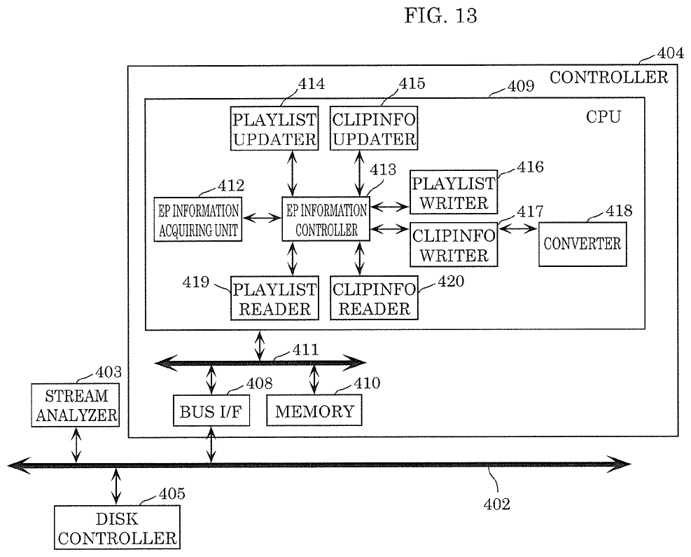

The recording operation of recording apparatus 400 illustrated in FIG. 12 will be described with reference to a detailed functional configuration of CPU 409. FIG. 13 is a block diagram illustrating the detailed functional configuration of CPU 409.

CPU 409 includes EP information acquiring unit 412, EP information controller 413, PLAYLIST updater 414, CLIPINFO updater 415, PLAYLIST writer 416, CLIPINFO writer 417, converter 418, PLAYLIST reader 419, and CLIPINFO reader 420.

EP information acquiring unit 412 acquires EP information from stream analyzer 403 and transmits the acquired EP information to EP information controller 413. EP information controller 413 transmits the EP information to PLAYLIST updater 414 and CLIPINFO updater 415. Based on the EP information, CLIPINFO updater 415 stores the I_end_position_offset in memory 410. At that time, the third GOP management table is used.

CLIPINFO updater 415 also acquires a TS Recording Rate of a video stream, and when the acquired TS Recording Rate is higher (greater) than a TS Recording Rate that is already stored, CLIPINFO updater 415 performs an update.

When recording of the video stream is finished, EP information controller 413 instructs PLAYLIST writer 416 to write a PLAYLIST file stored in memory 410 onto BD 500. EP information controller 413 additionally instructs CLIPINFO writer 417 to write a CLIPINFO file stored in memory 410 onto BD 500.

When receiving the instructions from EP information controller 413, CLIPINFO writer 417 checks the TS Recording Rate stored in memory 410, and when the TS Recording Rate is 48 Mbps or lower, CLIPINFO writer 417 instructs converter 418 to convert the I_end_position_offset from its value defined in the third GOP management table into its value defined in the first GOP management table. CLIPINFO writer 417 checks the TS Recording Rate stored in memory 410, and when the TS Recording Rate is higher than 48 Mbps, CLIPINFO writer 417 instructs converter 418 to convert the I_end_position_offset from its value defined in the third GOP management table into its value defined in the second GOP management table. CLIPINFO writer 417 thereafter instructs disk controller 405 to write the CLIPINFO file containing the converted I_end_position_offset onto BD 500.

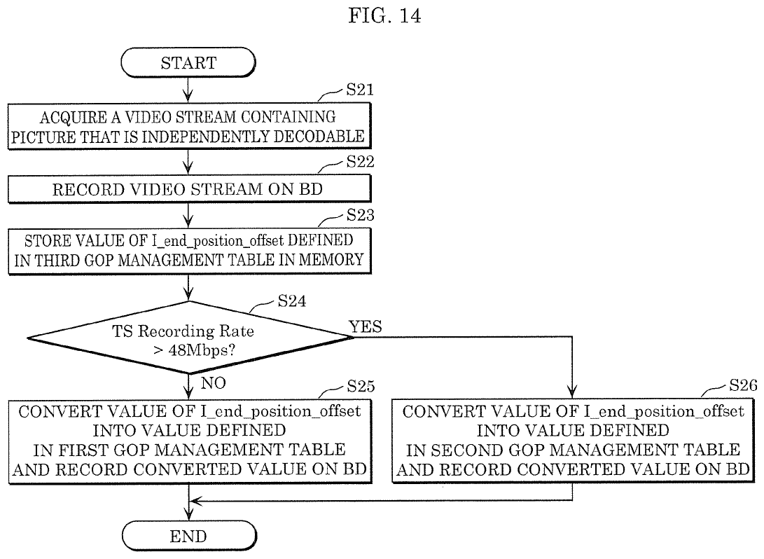

The recording operation described above can also be expressed as illustrated in FIG. 14. FIG. 14 is another flowchart of the recording operation of recording apparatus 400.

First, bus I/F 408 acquires a video stream that contains an I picture, which is independently decodable, through bus 402 (S21). CPU 409 records the acquired video stream on BD 500 (S22). CPU 409 refers to the third GOP management table stored in memory 410 to store temporarily a value of an I_end_position_offset defined in the third GOP management table in memory 410 (S23). The value of the I_end_position_offset is a value that indicates a data size of the I picture. The third GOP management table is a GOP management table made by merging the first GOP management table and the second GOP management table.

Note that, a range width of a data size of an I picture corresponding to a first value in the first GOP management table is 393216 bytes at the largest, as illustrated in FIG. 1. In contrast, a range width of a data size of an I picture corresponding to a second value in the second GOP management table is 786432 bytes, as illustrated in FIG. 2. That is, the range width of the data size of the I picture corresponding to the first value in the first GOP management table is narrower than the range width of the data size of the I picture corresponding to the second value in the second GOP management table.

Next, CPU 409 refers to a TS Recording Rate in a CLIPINFO file stored in memory 410 to determine whether the TS Recording Rate is higher than 48 Mbps (S24). In other words, CPU 409 determines whether a maximum bit rate of the video stream is higher than a predetermined value.

When determining that the TS Recording Rate is 48 Mbps or lower (No in S24), CPU 409 converts the value of the I_end_position_offset stored in step S23 into a value of the I_end_position_offset defined in the first GOP management table (hereafter, also referred to as a first value) and records the converted value on BD500 (S25). That is, when the maximum bit rate of the video stream is the predetermined value or lower, the value of the stored I_end_position_offset is converted into the first value.

When determining that the TS Recording Rate is higher than 48 Mbps (Yes in S24), CPU 409 converts the value of the stored I_end_position_offset into a value of the I_end_position_offset defined in the second GOP management table and records the converted value on BD500 (S26). That is, when the maximum bit rate of the video stream is higher than the predetermined value, the value of the stored I_end_position_offset is converted into the second value.

In such a manner, CPU 409 converts the value of the I_end_position_offset temporarily stored in memory 410 into either the first value defined in the first GOP management table or the second value defined in the second GOP management table. The value of the stored I_end_position_offset is specifically converted into either the first value or the second value based on the bit rate of the video stream.

Such recording apparatus 400 is capable of adaptively converting and recording a value indicating a data size of an I picture.

The value of the I_end_position_offset stored in step S23 is represented in four bits based on the third GOP management table, the first value is represented in three bits based on the first GOP management table, and the second value is represented in three bits based on the second GOP management table. That is, a number of bits of the value of the I_end_position_offset stored in step S23 is larger than a number of bits of the first value and a number of bits of the second value.

It is thereby possible to provide the third GOP management table, with which a value of an I_end_position_offset can be uniquely converted into a first value defined in the first GOP management table and a second value defined in the second GOP management table. In other words, the third GOP management table obtained by suitably merging the first GOP management table with the second GOP management table is provided.

### Advantageous Effects

As described above, the recording method performed by a computer such as recording apparatus 400 includes acquiring a video stream containing an I picture, which is independently decodable (S21), recording the acquired video stream on BD 500 (S22), storing, in memory 410, a value indicating a data size of an I picture defined in the third GOP management table obtained by merging the first GOP management table with the second GOP management table (S23), and converting the stored value into either a first value defined in the first GOP management table or a second value defined in the second GOP management table and recording the converted value on BD 500 (S25, S26). BD 500 is an example of a recording medium, and memory 410 is an example of a memory device. The first GOP management table is an example of first table information, the second GOP management table is an example of second table information, and the third GOP management table is an example of third table information.

Such a recording method is capable of adaptively converting and recording a value indicating a data size of an I picture.

The stored value is converted into one of the first value and the second value based on a bit rate of the video stream.

Such recording apparatus 400 is capable of adaptively converting and recording a value indicating a data size of an I picture according to a bit rate of a video stream.

In addition, for example, a range width of a data size of an I picture in the first GOP management table is narrower than a range width of a data size of an I picture in the second GOP management table. When the maximum bit rate of the video stream is the predetermined value or lower, the stored value is converted into the first value. When the maximum bit rate of the video stream is higher than the predetermined value, the stored value is converted into the second value. The predetermined value is, for example, but not limited to, 48 Mbps.

This causes a data size of an I picture contained in a video stream that has a relatively high maximum bit rate to be indicated based on the second GOP management table. Accordingly, a data size of an I picture contained in a video stream that has a relatively high maximum bit rate is caused to be indicated based on the second GOP management table, which prevents a value indicating the data size from being always a maximum value. That is, an advantageous effect provided is an effect of making it unlikely to result in a situation where a playback device has to read the entire GOP to acquire an I picture.

The number of bits of the stored value is larger than the number of bits of the first value and the number of bits of the second value.

It is thereby possible to provide the third GOP management table, with which a value stored in memory 410 can be uniquely converted into a first value defined in the first GOP management table and a second value defined in the second GOP management table. In other words, the third GOP management table obtained by suitably merging the first GOP management table with the second GOP management table is provided.

In addition, recording apparatus 400 includes bus I/F 408 that acquires a video stream containing a picture that is independently decodable, CPU 409 that records the acquired video stream on BD 500, and memory 410. Bus I/F 408 is an example of an acquiring unit, and CPU 409 is an example of a record controller. CPU 409 stores, in memory 410, a value indicating a data size of an I picture defined in the third GOP management table obtained by merging the first GOP management table with the second GOP management table, and converts the stored value into either the first value defined in the first GOP management table or the second value defined in the second GOP management table and records the converted value on BD 500.

Such recording apparatus 400 is capable of adaptively converting and recording a value indicating a data size of an I picture.

### Other Embodiments

An embodiment is described above, but the present invention is not limited to the above embodiment.

For example, in the above embodiment, the value of the I_end_position_offset stored in the memory is converted into either the first value or the second value based on the bit rate of the video stream. Such a conversion method is however an example. For example, the value of the I_end_position_offset may be converted into either the first value or the second value based on other kinds of physical quantities or information that indicate an amount of information on the video stream.

In addition, in the above embodiment, the BD is exemplified as a recording medium on which the video stream and the value of the I_end_position_offset are recorded, but the recording medium may be other kinds of optical disks such as DVD. The recording medium may be a recording medium other than optical disks, such as a hard disk and a semiconductor memory.

In addition, in the above embodiment, the value of the I_end_position_offset stored in the memory is converted into one of the two values but may be converted into one of three or more values.

Moreover, the general or specific aspects of the present disclosure may be realized by an apparatus, a system, a method, an integrated circuit, a computer program, or a computer-readable recording medium such as a CD-ROM, or by any combination of apparatuses, systems, methods, integrated circuits, computer programs, and recording media. The present disclosure may be realized as a program for causing a computer to execute the recording method according to the above embodiment, or as a non-transitory computer-readable recording medium having such a program recorded thereon.

In the above embodiment, processing executed by a particular processing unit may be executed by a different processing unit. Moreover, the processing order of a plurality of processes in the recording operation described in the above embodiment is a mere example. The processing order may be changed, and the plurality of processes may be performed in parallel.

In the above embodiment, each structural element may be realized through execution of a software program appropriate for the structural element. Each structural element may be realized as a result of a program execution unit such as a CPU or a processor reading and executing a software program recorded on a recording medium such as a hard disk or semiconductor memory. Each structural element may be realized as a single CPU or processor.

Moreover, each structural element may be realized by hardware. Specifically, each structural element may be realized bay a circuit or an integrated circuit. These circuits may be configured as a single circuit, or may be individual circuits. Moreover, these circuits may be general-purpose circuits, or may be specialized circuits.

Apart from the above, the present disclosure also encompasses embodiments obtained by applying various modifications conceivable to those skilled in the art to each embodiment, and embodiments realized by freely combining structural elements and functions of each embodiment without departing from the essence of the present disclosure.

### INDUSTRIAL APPLICABILITY

According to the present disclosure, a recorder is provided that can receive an MMT/TLV stream or a transport stream distributed over next-generation 4K/8K broadcasting or a communication network and record the MMT/TLV stream or the transport stream on a recording medium.

### REFERENCE MARKS IN THE DRAWINGS

100 recording system

200 antenna device

300 display device

400 recording apparatus

401 broadcast receiver

402 bus

403 stream analyzer

404 controller

405 disk controller

406 remote control receiver

407 remote control

408 bus I/F

409 CPU

410 memory

411 processor bus

412 EP information acquiring unit

413 EP information controller

414 PLAYLIST updater

415 CLIPINFO updater

416 PLAYLIST writer

417 CLIPINFO writer

418 converter

419 PLAYLIST reader

420 CLIPINFO reader

500 BD

501 PLAYLIST folder

502 CLIPINFO folder

503 STREAM folder

511 PLAYLIST file

512 CLIPINFO file

513 stream file

1. A recording method comprising:
acquiring a video stream containing a picture that is independently decodable;
recording the acquired video stream on a recording medium;
storing, in a memory device, a value that indicates a data size of the picture defined in third table information obtained by merging first table information with second table information; and
converting the stored value into one of a first value defined in the first table information and a second value defined in the second table information, and recording the converted value on the recording medium.

2. The recording method according to claim 1, wherein
the stored value is converted into one of the first value and the second value based on a bit rate of the video stream.

3. The recording method according to claim 2, wherein
a range width of a data size of the picture corresponding to the first value in the first table information is narrower than a range width of the data size of the picture corresponding to the second value in the second table information,
when a maximum bit rate of the video stream is a predetermined value or lower, the stored value is converted into the first value, and
when the maximum bit rate of the video stream is higher than the predetermined value, the stored value is converted into the second value.

4. The recording method according to claim 1, wherein
a number of bits of the stored value is larger than a number of bits of the first value and a number of bits of the second value.

5. A non-transitory computer-readable recording medium for use in a computer, the recording medium having a program recorded thereon for causing the computer to execute the recording method according to claim 1.

6. A recording apparatus comprising:
an acquiring unit that acquires a video stream containing a picture that is independently decodable;
a record controller that records the acquired video stream on a recording medium; and
memory, wherein
the record controller
stores, in the memory, a value that indicates a data size of the picture defined in third table information obtained by merging first table information with second table information, and
converts the stored value into one of a first value defined in the first table information and a second value defined in the second table information, and records the converted value on the recording medium.
